(19) United States
(12) Patent Application Publication
(10) Pub. No.: US 2009/0175140 A1
(43) Pub. Date: Jul. 9, 2009

(54) OPTICAL DISC APPARATUS

(76) Inventors: Toshiteru Nakamura, Yokohama (JP); Motoyuki Suzuki, Yokohama (JP); Fumio Isshiki, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/343,611

(22) Filed: Dec. 24, 2008

(30) Foreign Application Priority Data
Dec. 26, 2007 (JP) 2007-333445

(51) Int. Cl. G11B 20/10

(52) U.S. Cl. 369/47.14; G9B/20.009

(57) ABSTRACT

An optical disc apparatus which detects an envelope of a tracking error signal in a record or playback mode of an optical disc having recording layers of a multilayer structure, which quantifies a variation caused by multilayer interference (to ΔTES), and which restricts a recording or playback rate when a relationship ΔTES>Vth is satisfied for a predetermined threshold Vth. With such an arrangement, degradation of a recording or reproducing performance or generation of running-off-track resulting from a variation in the tracking error signal caused by stray light reflected by ones of recording layers of the optical disc which are not a recording or reproducing target layer can be suppressed, and a good recording or playback quality can be obtained even in such an optical disc having the plurality of recording layers laminated therein.

### INCORPORATION BY REFERENCE

The present application claims priority from Japanese application JP 2007-333445 filed on Dec. 26, 2007, the content of which is hereby incorporated by reference into this application.

### BACKGROUND OF THE INVENTION

The present invention relates to an optical disc apparatus which can record or reproduce data in or from recording layers of a multilayered structure in an optical disc.

As one background art in the technical field of the present application, there is known JP-A-2006-344344 (Patent Document 1) as an example. The Patent Document states that “a desired signal is accurately acquired from an optical disc having a plurality of recording layers” (see page 26, FIGS. 3 and 5). As another related prior art, there is known, for example, JP-A-2006-344380 (Patent Document 2). In this Patent Document, there is descried that “even when an optical storage recording medium having two information recording layers is used, a tracking error signal having less offset is detected” (see page 14, FIG. 1).

### SUMMARY OF THE INVENTION

In recent years, when recording or reproducing operation of information in an optical disc having recording layers of a multilayered structure, there are observed some problems as described below, in addition to a possibility of recording failure caused by face run-out, eccentricity or the like. More specifically, when information is recorded in or reproduced from the aforementioned multilayered optical disc, the tracking error signal is fluctuated or varied due to stray light reflected from the layers not used for the recording or reproduction, thus causing an offtrack. Depending upon the situation of the aforementioned offtrack caused by the multilayer interference variation, there occurs a problem that servo tracking becomes difficult to do, a phenomenon called running-off-track or derailing where tracking position control becomes impossible to do or cross-erase takes place, thus remarkably degrading a recording or playback quality.

It is therefore an object of the present invention to provide an optical disc apparatus which has a good recording or playback quality even in an optical disc having recording layers in a multilayered structure.

The above object is attained by inventions set forth in claims as an example. Typical ones of the inventions disclosed in the present application will be briefly explained as follows.

In accordance with an aspect of the present invention, there is provided an optical disc apparatus which includes an optical pickup device having an optical detector for receiving a laser light beam applied onto an optical disc and reflected therefrom, a servo signal generation circuit for generating a focusing error signal and a tracking error signal using a signal detected by the optical detector in the optical pickup device, and an information signal recording/reproducing circuit for recording an information signal in the optical disc and reproducing the information signal recorded in the optical disc. When information is recorded and/or reproduced in and/or from the optical disc having recording layers in a multilayer structure in its one surface, an amount of offtrack caused by a multilayer interference variation is detected, and a recording rate and/or a reproduction rate is limited according to the amount of offtrack caused by the multilayer interference variation.

In accordance with the present invention, there can be provided an optical disc apparatus which can have a good stability and a good recording or playback quality.

### BRIEF DESCRIPTION OF THE DRAWINGS

These and other features, objects and advantages of the present invention will become more apparent from the following description when taken in conjunction with the accompanying drawings wherein:

FIG. 1 schematically shows an arrangement of an optical disc apparatus in accordance with the present invention;

FIGS. 2A and 2B schematically show configurations of a multilayer variation detection circuit as a major section of a first embodiment respectively;

FIGS. 3A and 3B show signal waveform diagrams for explaining the operation of the multilayer variation detection circuit in the first embodiment;

FIG. 4 is a flow chart showing a procedure of recording/playback rate adjusting operation in the present invention; and

FIG. 5 schematically shows a configuration of a multilayer variation detection circuit as a major section of a second embodiment.

### DETAILED DESCRIPTION OF THE EMBODIMENTS

Embodiments of the present invention will be explained in detail with reference to the attached drawings. In this connection, constituent elements having the same operational functions are denoted by the same reference numerals in the drawings.

### Embodiment 1

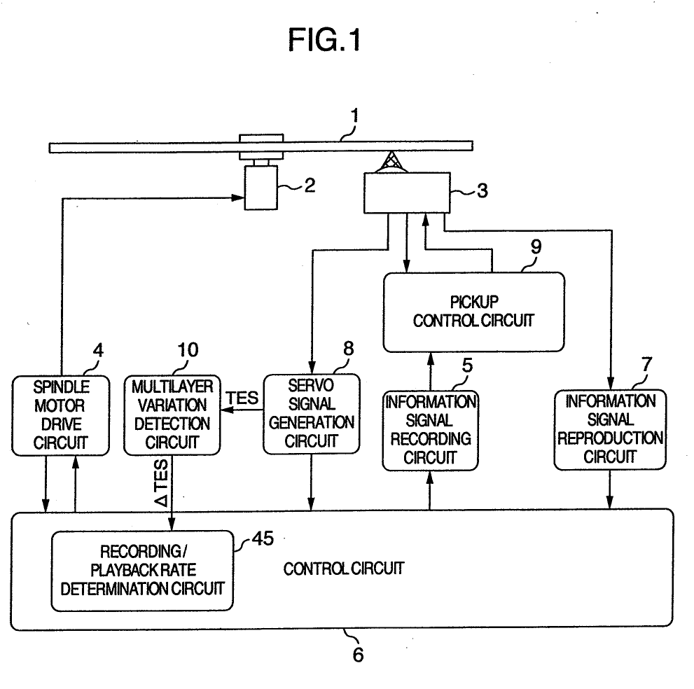

FIG. 1 schematically shows an example of an arrangement of an optical disc apparatus in accordance with the present invention. In the present embodiment, a recordable optical disc 1 is rotated by a spindle motor 2 so that a light beam emitted from a laser light source mounted in an optical pickup device 3 is applied onto the optical disc 1 to record or reproduce data therein or therefrom. The laser light beam applied onto the optical disc is reflected by a recording layer and guided into an optical detector in the optical pickup device 3 to output an electric signal according to the intensity of the light incident to the detector.

A control circuit 6 controls the operation of the entire optical disc apparatus. The control circuit 6 controls the rotational speed of the spindle motor through a spindle motor drive circuit 4. The spindle motor feeds the rotational speed of the optical disc back to the control circuit 6.

In a record mode, the control circuit 6 outputs record information to an information signal recording circuit 5. The information signal recording circuit 5 controls the waveform of the laser light beam emitted from the laser light source mounted in the optical pickup device under control of a pickup control circuit 9 to write information in the optical disc. In a reproduction or playback mode, an information signal reproduction circuit 7 reproduces information based on an output signal from the optical detector and outputs it to the control circuit 6.

A servo signal generation circuit 8, when receiving the output signal from the optical detector, generates a focusing error signal and a tracking error signal (TES) as servo signals. The control circuit 6, upon receiving the servo signals, feeds the servo signals to the pickup control circuit 9 to drive an actuator mounted in the optical pickup device, to control the focus position and tracking position of an objective lens, and to record or reproduce information accurately and stably.

When the tracking error signal generated by the servo signal generation circuit 8 during control of the focus position alone is input to a multilayer variation detection circuit 10, the multilayer variation detection circuit 10 outputs a value corresponding to an offtrack as a shift between an optical spot position on the optical disc at the time of the tracking position control and a track position formulated on the optical disc. A recording/playback rate determination circuit 45 in the control circuit 6, when receiving an output signal (ΔTES) from the multilayer variation detection circuit 10, determines a recording or playback rate enabling maintenance of a good recording or playback quality. According to an output of the recording/playback rate determination circuit 45, the control circuit 6 feeds information back to the spindle motor drive circuit 4, the information signal recording circuit 5 and the information signal reproduction circuit 7 to adjust the recording or playback rate.

Explanation will next be made as to a new problem when information is recorded or reproduced in or from an optical disc having recording layers in a multilayer configuration in its one surface.

When it is desired to record or reproduce information in or from the optical disc having recording layers in a multilayer structure, a laser light beam is focused on one (which recording layer will be hereinafter referred to as the target layer) of the recording layers as a signal recording/reproducing target, and light reflected by the target layer is detected. At this time, a part of the amount of the light is not reflected by the target layer but reflected by the recording layers (which will be hereinafter referred to as the other layers) other than the target layer. A light beam (which will be hereinafter referred to as stray light) reflected by the other layers is guided along an optical path nearly similar to the light beam (which will be hereinafter referred to as signal light) reflected by the target layer and applied to respective light receiving surfaces of the optical detector. The stray light interferes with the intended signal light on the light receiving surfaces to generate interference fringes. Bright and dark parts in the interference fringes cause a light quantity balance to be disturbed on the respective light receiving surfaces and result in generation of an unnecessary multilayer interference variation component, which affects output signals from the respective light receiving surfaces.

For example, when a spacing or distance between respective recording layers of the multilayered optical disc varies, an interval or distance between light lines in the interference fringes is varied on the optical detector according to the varied layer spacing. This may vary the position of the interference fringes or the number of interference fringe lines appearing on the light receiving surfaces of the detector and result in generation of a multilayer interference variation component, thereby producing an offset in a tracking error signal. Since the interference fringes are continuously varied with the layer spacing, this variation causes an AC-like offset to generate in a waveform having a period lower than that of a push-pull signal. With respect to an optical disc having, in particular, 3 or more recording layers in a multilayered structure, the presence of a plurality of other layers than the layer of interest causes generation of a plurality of stray light fluxes which are applied onto the optical detector, with the result of a large degree of variation caused by the interference. If the tracking position control is carried out using the aforementioned tracking error signal, the tracking error signal will be controlled to have a constant value to thereby carry out an additional surplus objective lens shifting operation so as to cancel out the aforementioned multilayer interference variation component. Accordingly, the multilayer interference variation causes generation of offtrack. The offtrack caused by the aforementioned multilayer interference variation will generate cross-erase and also make it difficult to carry out the servo tracking, resulting in problems, such as the running-off-track or derailing in which the tracking position control becomes impossible, thereby degrading a recording or playback quality.

In particular, when the recording or reproducing operation is carried out at high speeds, occurrence of offtrack causes the loss-of-track to tend to take place and the recording or playback quality becomes largely degraded.

In the present embodiment, there is provided an optical disc apparatus which can suppress the loss-of-track by detecting the amount of the offtrack caused by the multilayer interference variation and by adjusting a recording/playback rate according to the amount of the offtrack, and therefore which can have a good recording or playback quality.

The detection of the amount of the offtrack caused by the multilayer interference variation and the adjustment of the recording/playback rate can be attained, for example, with an arrangement which follows.

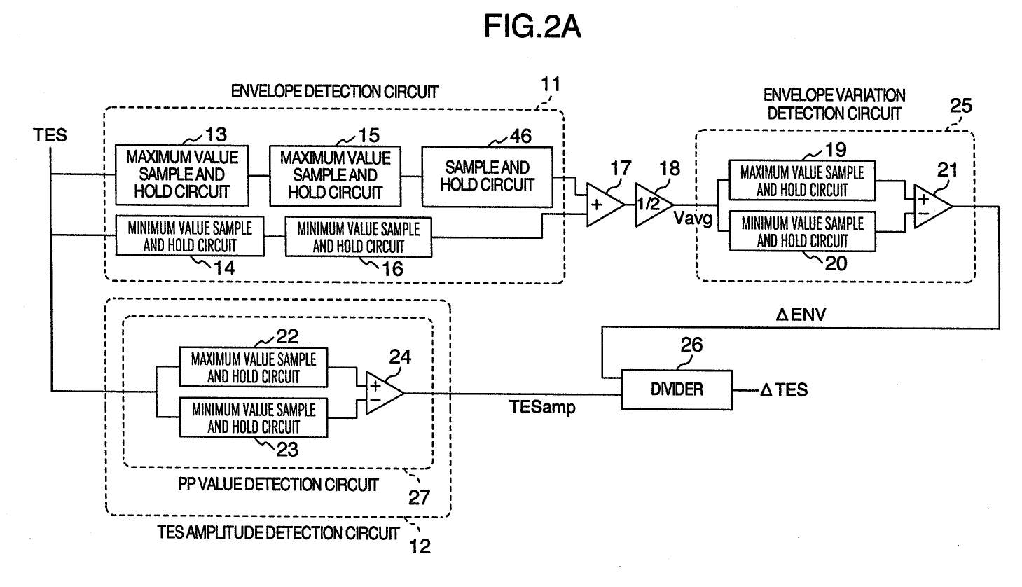

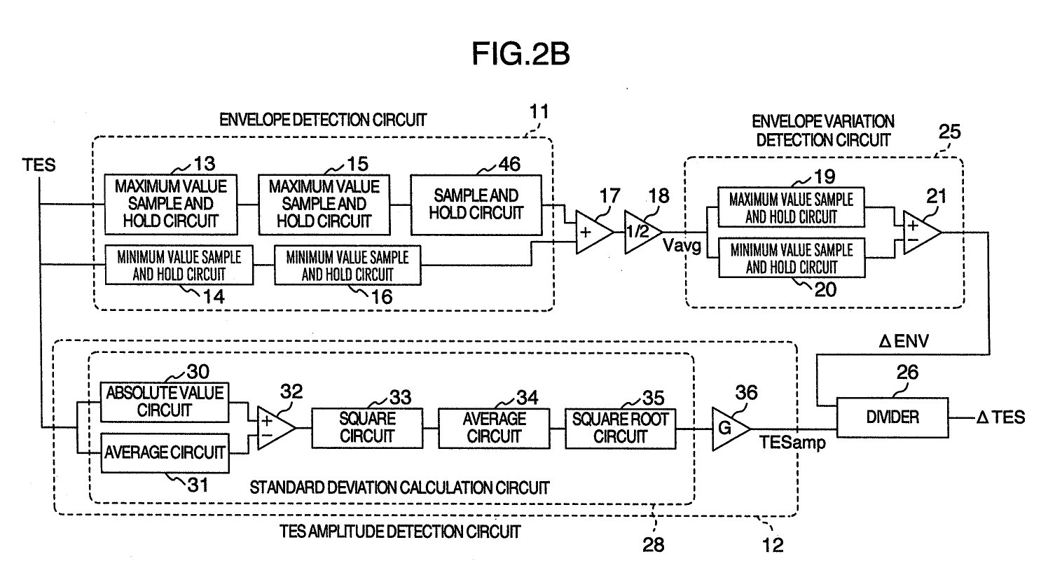

FIG. 2A schematically shows an example of a configuration of the multilayer variation detection circuit 10 shown in FIG. 1. The multilayer variation detection circuit 10 is inputted with a tracking error signal which is generated in the state in which only the focus position control is being carried out and no track position control is not performed. If track position control is carried out as described above, the tracking error signal is controlled to have a predetermined value. For this reason, even when a variation in the tracking error signal generated in the state in which the track position control is conducted, is evaluated, it will be difficult to estimate the amount of the generated offtrack caused by the multilayer interference.

The tracking error signal inputted to the multilayer variation detection circuit 10 during the focus position control alone is being conducted, is inputted to an envelope detection circuit 11 and also to a tracking error signal amplitude detection circuit 12.

The envelope detection circuit 11 performs envelope detection over the tracking error signal. The envelope detection may be carried out with such an envelope detection circuit 11 that has, for example, such an arrangement as to be given in the following. In the envelope detection circuit 11, an input signal is inputted to a maximum value sample and hold circuit 13 and also to a minimum value sample and hold circuit 14. During the focus position control alone is being carried out, the output of the tracking error signal has a sinusoidal waveform. Thus, the maximum value sample and hold circuit 13 and the minimum value sample and hold circuit 14 reset the sample and hold operation at intervals of one period of the tracking error signal. The sample and hold resetting timing of the maximum value sample and hold circuit 13 is set desirably at a zero cross point immediately before a maximum value in one period of the sinusoidal output of the tracking error signal. The sample and hold resetting timing of the minimum value sample and hold circuit 14 is set desirably at a zero cross point immediately before a minimum value in one period of the sinusoidal output of the tracking error signal. Therefore, the sample and hold resetting timings of the maximum value sample and hold circuit 13 and the minimum value sample and hold circuit 14 are shifted from each other desirably by half of one period of the sinusoidal output.

An output signal of the maximum value sample and hold circuit 13 and an output signal of the minimum value sample and hold circuit 14 are input to a maximum value sample and hold circuit 15 and to a minimum value sample and hold circuit 16 provided at downstream stages respectively. However, it is assumed that the resetting timing of the maximum value sample and hold circuit 15 is shifted by half of one period of the tracking error signal output from the resetting timing of the maximum value sample and hold circuit 13. It is also assumed that the resetting timing of the minimum value sample and hold circuit 16 is shifted by half of one period of the tracking error signal output from the resetting timing of the minimum value sample and hold circuit 14. At this time, an output signal of the maximum value sample and hold circuit 15 and an output signal of the minimum value sample and hold circuit 16 may be set to have a top envelope value (Vtop) and a bottom envelope value (Vbottom) respectively, but the resetting timings of the maximum value sample and hold circuit 15 and the minimum value sample and hold circuit 16 are shifted from each other by half of one period of the tracking error signal output. In order to make the sample and hold resetting timing of the top envelope value (Vtop) coincide with the sample and hold resetting timing of the bottom envelope value (Vbottom), an output signal from the maximum value sample and hold circuit 15 may be received at a sample and hold circuit 46 to perform sample and hold resetting operation nearly at the same timing as the minimum value sample and hold circuit 16. Thus an output signal of the sample and hold circuit 46 and an output signal of the minimum value sample and hold circuit 16 may be set to have the top envelope value (Vtop) of the tracking error signal and the bottom envelope value (Vbottom) thereof, respectively.

The values Vtop and Vbottom are added by an adder 17, and an output signal from the adder is inputted to an attenuator 18 having an attenuation factor of ½. An output signal of the attenuator 18 has an envelope average value (Vavg) corresponding to an average of the values Vtop and Vbottom.

The value Vavg is inputted to an envelope variation detection circuit 25 to detect an amount of an envelope variation. The envelope variation detection circuit 25 may have an arrangement which follows.

The input value Vavg is inputted to a maximum value sample and hold circuit 19 and also to a minimum value sample and hold circuit 20. The maximum value sample and hold circuit 19 and the minimum value sample and hold circuit 20 have an output signal corresponding to a maximum value (Vavg_Max) of the value Vavg and an output signal corresponding to a minimum value (Vavg_Min) of the value Vavg, respectively. The values Vavg_Max and Vavg_Min are inputted to a subtracter 21 to find a difference therebetween. It is assumed that an output signal of the subtracter 21 has an envelope variation (ΔENV).

The sample and hold circuit 46 is arranged so that the sample and hold resetting timings of the circuits for detecting the top and bottom envelope signals are made nearly to coincide with each other. As a result, the influence of such a flaw on an optical disc that causes the signals Vtop and Vbottom to vary symmetrically, can be canceled out upon calculation of Vavg, and a purer multilayer interference variation component alone can be measured as the value ΔENV.

The tracking error signal amplitude detection circuit 12, when receiving the tracking error signal, performs amplitude detection over the received tracking error signal. The tracking error signal amplitude detection circuit may have, for example, an arrangement which follows.

The tracking error signal inputted to the tracking error signal amplitude detection circuit 12 is inputted to a PP value detection circuit 27 to detect a peak to peak value (PP value). The tracking error signal inputted to the PP value detection circuit 27 is inputted to a maximum value sample and hold circuit 22 and to a minimum value sample and hold circuit 23 in the PP value detection circuit 27. From respective output signals of the maximum value sample and hold circuit 22 and the minimum value sample and hold circuit 23, maximum and minimum values of the tracking error signal are obtained. The output signal of the maximum value sample and hold circuit 22 and the output signal of the minimum value sample and hold circuit 23 are inputted to a subtracter 24 to find a difference therebetween so that a tracking error signal amplitude (TESamp) can be detected.

A variation (ΔTES) is obtained by dividing the value ΔENV by the value TESamp at a divider 26. Accordingly, the value (ΔTES) can be obtained by inputting the tracking error signal to the multilayer variation detection circuit. The value ΔTES is proportional to the amount of the offtrack. An increase in the amount of the offtrack means an increase in a running-off-track or derailing occurrence probability. Thus, a degree of the occurrence of the running-off-track or derailing influenced by the multilayer interference variation can be detected using the value ΔTES.

In this connection, the method of detecting the value ΔTES is not limited to the arrangement of the multilayer variation detection circuit 10 in the present embodiment, so long as the circuit can output a value corresponding to the amount of the offtrack. Thus the multilayer variation detection circuit 10 may have such an arrangement as in FIG. 2B. FIG. 2B is different from FIG. 2A in the arrangement of the tracking error signal amplitude detection circuit 12. When the influence of the multilayer variation or such a disturbance as electric noise is great and a tracking error signal is largely disturbed, the arrangement of FIG. 2A for finding the tracking error signal amplitude from the maximum and minimum values thereof may increase an amplitude measurement error in some cases. In order to avoid it, the tracking error signal amplitude detection circuit 12 in the multilayer variation detection circuit 10 may have such an arrangement as shown in FIG. 2B. In this connection, an arrangement other than the tracking error signal amplitude detection circuit 12 may be made similar to that of the multilayer variation detection circuit 10 of FIG. 2A.

Explanation will be made as to the arrangement of the tracking error signal amplitude detection circuit 12 in the multilayer variation detection circuit 10 shown in FIG. 2B. Inputting of the tracking error signal to the tracking error signal amplitude detection circuit 12 causes a standard deviation calculation circuit 28 to find a standard deviation for the tracking error signal. An input signal of the standard deviation calculation circuit 28 is inputted to an absolute value circuit 30 and also to the average circuit 31 to cause a subtracter 32 to find a difference between an output signal of the absolute value circuit 30 and an output signal of the average circuit 31. An output signal of the subtracter 32 is then applied to a square circuit 33 provided downstream thereof, an output signal of the square circuit 33 is applied to an average circuit 34, and an output signal of the average circuit 34 is applied to a square root circuit 35. An output signal of the square root circuit 35 corresponds to an output signal of the standard deviation calculation circuit 28, which output signal indicates a standard deviation of the tracking error signal. The output signal of the standard deviation calculation circuit 28 is applied to an amplifier 36 to be amplified thereat with a predetermined amplification factor G, and an amplified output signal of the amplifier corresponds to a tracking error signal amplitude. At this time, the amplification factor G of the amplifier 36 is set desirably at some 2.83.

Though not specifically illustrated, selection between use of the arrangement of the PP value detection circuit 27 shown in FIG. 2A and use of the arrangement of the standard deviation calculation circuit 28 shown in FIG. 2B as the tracking error signal amplitude detection circuit 12 can be made by a predetermined switching means, whereby the tracking error signal amplitude can be detected with use of any of the output signals of the circuits 27 and 28.

The circuit for detecting the tracking error signal amplitude using the PP value detection circuit in the PP value detection circuit of FIG. 2A can be used even for a circuit arrangement for searching for a flaw on a disc. Since the present invention is arranged so that the tracking error signal amplitude can be detected with use of any of the PP value detection circuit 27 and the standard deviation calculation circuit 28, a good recording or playback quality can be obtained even for an optical disc having not only a multilayer interference variation but also a defect, thus enhancing the versatility of the optical pickup device.

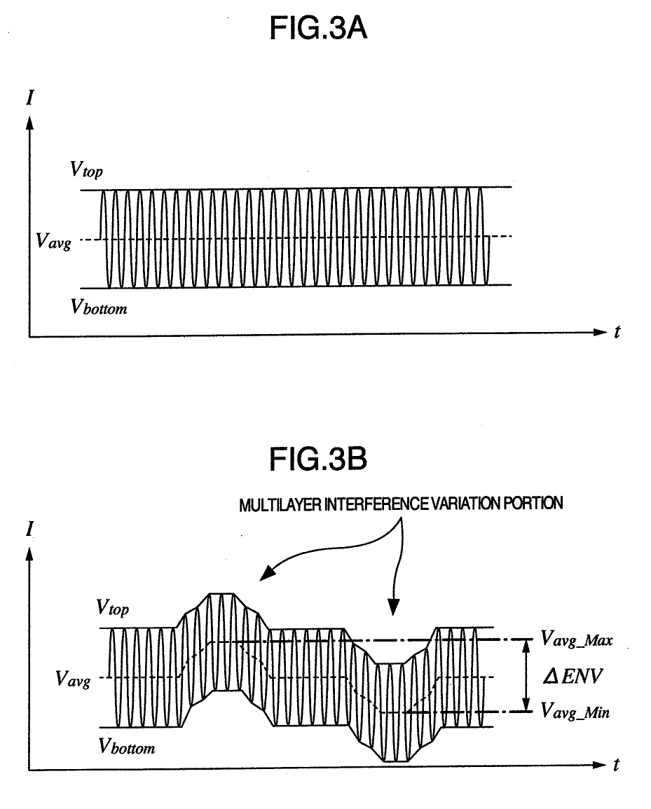

FIGS. 3A and 3B schematically show waveforms of a tracking error signal when focus position control alone is carried out. Also illustrated in the drawings are not only the values Vtop and Vbottom but also the signal Vavg obtained by the multilayer variation detection circuit. FIG. 3A schematically shows the tracking error signal when a disc having a single recording layer is used. Because of no occurrence of the multilayer interference, the values Vtop, Vbottom and Vavg obtained by the envelope detection circuit are not largely varied. Accordingly, the value ΔTES becomes small and a generated offtrack can be determined to be very small.

FIG. 3B schematically shows a typical example of the waveform of the tracking error signal when an optical disc having a plurality of recording layers in a multilayered configuration is used. As mentioned above, the multilayer interference variation causes the tracking error signal to vary with the varied spacing between the recording layers. Thus, since occurrence of an offset depends on the variation of the spacing between the recording layers, even a variation in the value ΔENV has a positional dependency in the same disc. In FIG. 3B, the location shown as multilayer interference variation portion corresponds to the variation portion of the spacing between the recording layers and a large offset occurs in the tracking error signal in accordance with the variation of the layer spacing. It will be seen that the offset causes an increase of the value ΔENV. Thus a large value ΔTES is detected for the multilayered optical disc. The value ΔTES also has a positional dependency within the same disc and similarly, the value ΔTES becomes different disc by disc. Since a large offtrack takes place at a position having a large value ΔTES on the disc, a running-off-of track or derailing generation probability is increased. In particular, the higher a recording/playback rate is, the higher the running-off-of track or derailing generation probability is, and the more difficult stable tracking is.

In the recording/playback rate determination circuit 45 provided in the control circuit 6 for receiving the output signal ΔTES of the multilayer variation detection circuit 10, a voltage comparator provided therein compares the magnitude of the voltage ΔTES with a predetermined recording/playback rate adjustment determination threshold (Vth). When a relationship, ΔTES<Vth, is satisfied as the comparison result of the recording/playback rate determination circuit 45, the control circuit 6 determines “absence of danger of the running-off-track or derailing” and the recording or playback rate is not reduced. When a relationship ΔTES>Vth is satisfied, the control circuit 6 determines “presence of danger of the running-off-track or derailing” and feeds signals back to the spindle motor drive circuit 4, the information signal recording circuit 5 and the information signal reproduction circuit 7 to restrict the recording or playback rate to suppress the running-off-track.

As mentioned above, the value ΔTES varies depending upon the disc position. Accordingly, the running-off-track or derailing generation probability also varies depending upon the optical disc position. Thus, if a determination result for one region on the optical disc is applied to the recording or reproducing operation over the entire optical disc, this means that the accuracy of determination for restricting the recording or playback rate is reduced. For this reason, it is desirable to detect the amount of the offtrack at a plurality of positions over the optical disc extending from inner to outer circumferences in the present embodiment. As a result, the recording or playback rate can be managed more accurately, the running-off-track or derailing can be suppressed from taking place, and the recording/playback rate can be prevented from being unnecessarily reduced, to advantage. It is also desirable to detect ΔTES by performing measurement over a full circumference or more at each radius position of the optical disc, instead of performing measurement on part of a circumference at each radius position. In addition, by providing a plurality of determination thresholds so as to stepwise adjust the recording or playback rate, the restriction of the recording or playback rate beyond its necessity can be further avoided.

Circuit operation similar to the multilayer variation detection circuit 10 shown in the present embodiment may be implemented through digital signal processing.

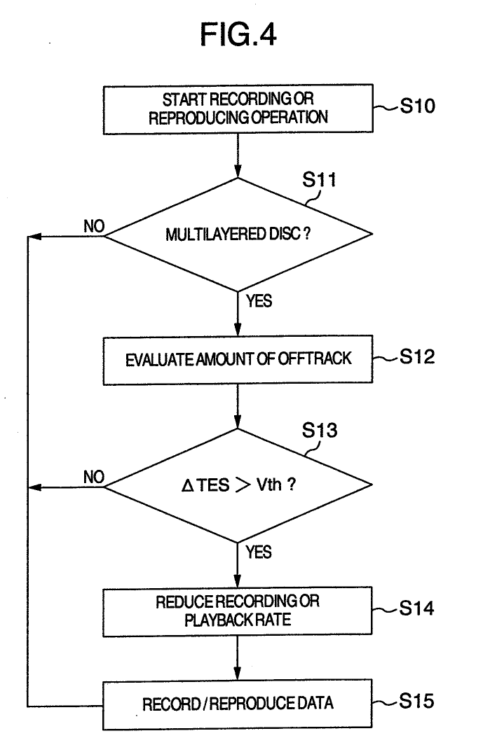

FIG. 4 is a flow chart showing a procedure of multilayer variation detection and rate adjustment in the present embodiment. In a step S10, the apparatus starts its recording or reproducing operation. In step S11, the apparatus determines the number of recording layers in an optical disc according to a focusing error signal. When the disc has a single recording layer, the apparatus performs data recording or reproducing operation in step S15. When the disc is a multilayered disc, on the other hand, the apparatus evaluates the offtrack ΔTES in step S12. In step S13, the apparatus compares the value ΔTES with a predetermined threshold Vth. When a relationship ΔTES>Vth is satisfied, the apparatus reduces the recording or playback rate and executes data recording or reproducing operation in step S15. When a relationship ΔTES<Vth is satisfied, the apparatus does not reduce the recording or playback rate and executes the data recording or reproducing operation of step S15. The determination of the number of recording layers of the optical disc in step S11 may be carried out when the optical disc apparatus is started prior to step S10.

Since an amount of generated offtrack caused by multilayer variation shown in the present embodiment is different between optical discs or between optical pickup devices, it is also possible that the apparatus is used to evaluate the performances of the optical disc alone or of the optical pickup device alone using the multilayer variation detection circuit 10. In other words, the multilayer variation detection circuit 10 can be used as a multilayer variation performance evaluation device of the optical disc or optical pickup device.

In conclusion, according to the present embodiment, there is provided an optical disc apparatus which includes an optical pickup device having an optical detector for receiving light of a laser light beam applied onto an optical disc which is reflected by the optical disc, a servo signal generation circuit for generating a focusing error signal and a tracking error signal using a signal detected by the optical detector within the optical pickup device, an information signal recording/reproducing circuit for recording an information signal in the optical disc or for reproducing the information signal recorded in the optical disc, a circuit for detecting an amplitude of the tracking error signal, an envelope signal detection circuit for detecting a top envelope signal and a bottom envelope signal in the tracking error signal, an average value calculation circuit for calculating an average value (Vavg) of the top envelope signal and the bottom envelope signal, an envelope variation detection circuit for detecting an envelope variation amount (ΔENV) from the average value Vavg, a multilayer variation detection circuit for calculating a value (ΔTES) corresponding to an amount of the offtrack caused by a multilayer interference variation in a record or playback mode of the optical disc having a multilayered recording layers on its one surface on the basis of a ratio in amplitude value between the value ΔENV and the tracking error signal, and a recording/playback rate determination circuit for determining necessity or non-necessity of recording/playback rate adjusting operation according to the value ΔTES. The optical disc apparatus adjusts the recording or playback rate according to the determination of the recording/playback rate determination circuit. By using such an optical disc apparatus, the running-off-track or cross-erase when recording or reproducing operation of the optical disc having multilayered recording layers is carried out can be suppressed, and a good recording or playback quality can be attained.

### Embodiment 2

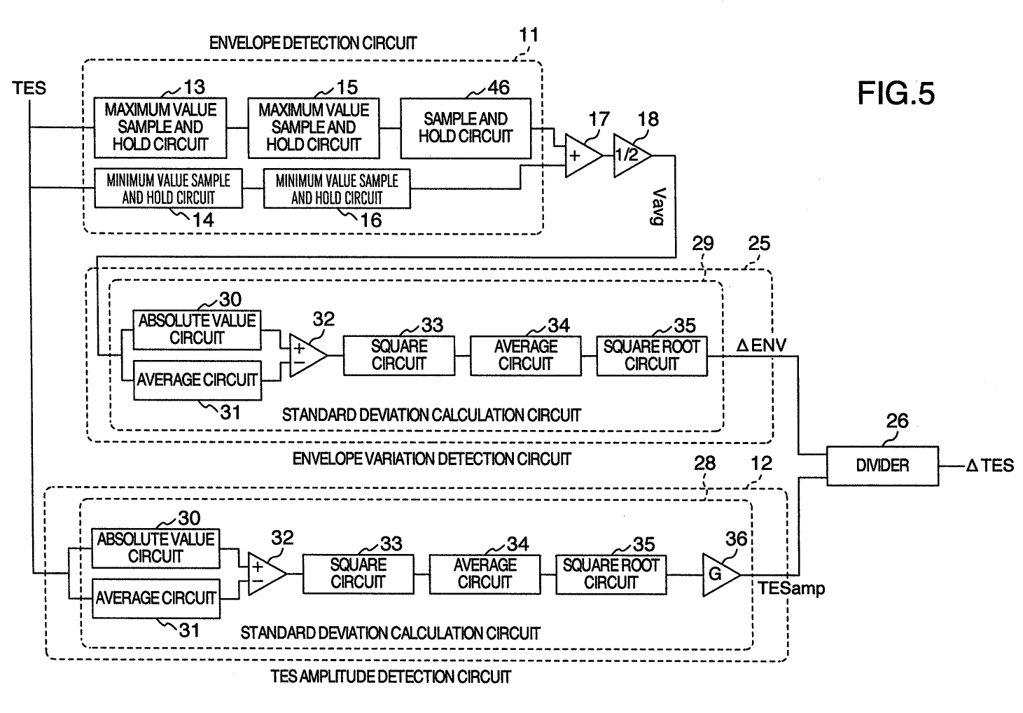

Explanation will next be made as to a second embodiment by referring to FIG. 5. In the present embodiment, the running-off-track generation probability caused by the aforementioned multilayer interference variation can be estimated more accurately. Accordingly, there can be provided an optical disc apparatus having a recording or playback quality better than that of the first embodiment.

The optical disc apparatus according to the present embodiment may have, for example, an arrangement similar to the optical disc apparatus of FIG. 1. The second embodiment is different from the first embodiment in the arrangement of the envelope variation detection circuit 25 included in the multilayer variation detection circuit 10 shown in FIG. 2A or 2B.

FIG. 5 shows a multilayer variation detection circuit 10 as a major part of the second embodiment. In the present embodiment, the envelope detection circuit 11 and the tracking error signal amplitude detection circuit 12 may have arrangements similar to those shown in FIG. 2B of the first embodiment. Though not specifically illustrated, as in the first embodiment, the tracking error signal amplitude detection circuit 12 may have such an arrangement as to use the PP value detection circuit shown in FIG. 2A, or changeover between the PP detection circuit and the standard deviation calculation circuit may be made by a predetermined switching means.

The value Vavg inputted to the envelope variation detection circuit 25 is inputted to a standard deviation calculation circuit 29 to find a standard deviation for the value Vavg. The standard deviation calculation circuit 29 may have an arrangement similar to that of the standard deviation calculation circuit 28. The standard deviation calculation circuit 29 produces an output signal ΔENV, which in turn is used for ΔTES detection.

As a result of study conducted by the inventors, it has been found that, in an actual optical disc apparatus, when a multilayer variation region is large along a time axis, the running-off-track tends to easily take place even when the amount of offtrack is same. Even when a time-wise variation region is long in the PP value ΔENV detection, a similar value is obtained so long as no variation takes place in maximum and minimum values. However, by carrying out the ΔENV detection based on standard deviation, the ΔENV detection which takes a ratio of the time-wise varying region into consideration, can be realized. As a result, the value ΔTES taking the degree of the aforementioned time-wise variation, can be detected.

In the present embodiment, in addition to the aforementioned reason, the influence of local envelope variation on the value ΔTES tends to be lightened. This results in advantages that the influence of a flaw on the optical disc or of electric noise which locally varies the envelope as compared to the multilayer interference variation, can be lightened, and that only a variation component caused by the multilayer interference can be detected.

In this way, in the present embodiment, the value ΔTES having a higher correlation with the running-off-track caused by the multilayer interference variation can be detected. Thus the recording/playback rate determination circuit 45 provided in the control circuit 6 can determine the necessity or non-necessity of the recording/playback rate adjusting operation more accurately for the running-off-track. Therefore the present embodiment advantageously provides for an optical disc apparatus with a good recording or playback quality which can suppress the running-off-track in the record or playback mode of the multilayered disc to an extent nearly equal to or higher than in the first embodiment.

Circuit operation similar to the multilayer variation detection circuit 10 shown in the present embodiment may be implemented through digital signal processing operation.

In the optical disc apparatus of the present embodiment, the envelope variation detection circuit includes the standard deviation calculation circuit for finding a standard deviation for the value Vavg, and the standard deviation for the value Vavg outputted from the standard deviation calculation circuit is used as ΔENV. By virtue of the use of such an optical disc apparatus, the running-off-track generation probability caused by the multilayer interference variation can be detected more accurately. As a result, there can be provided such an optical disc apparatus that has a accurate and stable recording or playback quality.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. An optical disc apparatus, comprising:
an optical pickup device having an optical detector for receiving light of a laser light beam applied onto an optical disc which is reflected by the optical disc;
a servo signal generation circuit for generating a focusing error signal and a tracking error signal using a signal detected by the optical detector in the optical pickup device;
an information signal recording/reproducing circuit for recording an information signal in the optical disc or reproducing the information signal recorded in the optical disc;
a circuit for detecting an amplitude of the tracking error signal;
an envelope signal detection circuit for detecting a top envelope signal and a bottom envelope signal of the tracking error signal;
an average value calculation circuit for calculating an average value (Vavg) of the top envelope signal and the bottom envelope signal;
an envelope variation detection circuit for detecting an amount of an envelope variation (ΔENV) from the average value Vavg; and
a multilayer variation detection circuit for calculating a value (ΔTES) corresponding to an amount of an offtrack caused by a multilayer interference variation in a record or playback mode of the optical disc having recording layers of a multilayer structure on its one surface on the basis of a ratio between the value ΔENV and the tracking error signal amplitude.

2. An optical disc apparatus according to claim 1, wherein the envelope variation detection circuit includes a maximum value hold circuit for detecting a maximum value of the value Vavg and a minimum value hold circuit for detecting a minimum value of the value Vavg, and detects as the value ΔENV a difference between the output signal of the maximum value hold circuit and the output signal of the minimum value hold circuit.

3. An optical disc apparatus according to claim 1, wherein the envelope variation detection circuit includes a standard deviation calculation circuit for finding a standard deviation of the average value Vavg, and the standard deviation of the value Vavg outputted from the standard deviation calculation circuit is used as the value ΔENV.

4. An optical disc apparatus according to claim 1, wherein the tracking signal amplitude detection circuit includes a maximum value hold circuit for detecting a maximum value of the tracking error signal and a minimum value hold circuit for detecting a minimum value of the tracking error signal, and detects a difference between an output signal of the maximum value hold circuit and an output signal of the minimum value hold circuit as a tracking signal amplitude.

5. An optical disc apparatus according to claim 1, wherein the tracking signal amplitude detection circuit includes a standard deviation calculation circuit for calculating a standard deviation of the tracking error signal and an amplifier for amplifying an output of the standard deviation calculation circuit with a predetermined amplification factor, and detects an output signal of the amplifier as a tracking signal amplitude.

6. An optical disc apparatus according to claim 1, wherein a sample and hold resetting timing of the top envelope value outputted from the envelope signal detection circuit is made to substantially coincide with a sample and hold resetting timing of the bottom envelope value.

7. An optical disc apparatus according to claim 1, further comprising a recording/playback rate determination circuit for determining necessity or non-necessity of recording/playback rate adjusting operation by comparing an output voltage of the multilayer variation detection circuit with a predetermined recording/playback rate adjustment determination threshold with use of a voltage comparator, and wherein, when the output value of the multilayer variation detection circuit is larger than the recording/playback rate adjustment determination threshold, a recording or playback rate is restricted.

8. An optical disc apparatus according to claim 1, wherein detection of an amount of generated offtrack is carried out by the multilayer variation detection circuit by a plural number of times according to radius positions of the optical disc, comparison between an output value of the multilayer variation detection circuit and the recording/playback rate adjustment threshold at each of the radius positions is carried out by the recording/playback rate determination circuit, and necessity or non-necessity of recording/playback rate adjusting operation is determined according to the radius position and executed by the recording/playback rate determination circuit.

9. An optical disc apparatus comprising:
an optical pickup device having an optical detector for receiving light of a laser light beam applied onto an optical disc which is reflected by the optical disc;
a servo signal generation circuit for generating a focusing error signal and a tracking error signal using a signal detected by the optical detector provided in the optical pickup device; and
an information signal recording/reproducing circuit for recording an information signal in the optical disc and reproducing the information signal recorded in the optical disc,
wherein, in a record and/or playback mode of the optical disc having recording layers of a multilayer structure on its one surface, an amount of generated offtrack caused by multilayer interference variation is detected and a recording rate and/or a reproducing rate is restricted according to the amount of the generated offtrack caused by the multilayer interference variation.

10. A recording/reproducing rate control method for an optical disc apparatus capable of recording or reproducing information in or from a multilayered optical disc having a plurality of recording layers and also in a single layer optical disc having a single recording layer, the method comprising:
a first step of determining the number of recording layers of the optical disc according to a focusing error signal;
a second step of detecting an amount of offtrack from a tracking error signal when the optical disc is determined as the multilayered optical disc as a result of the first step;
a third step of comparing the amount of the offtrack detected in the second step with a magnitude of a predetermined recording/playback rate adjustment determination threshold; and
a fourth step of limiting a recording or playback rate when the offtrack is larger than the recording/playback rate adjustment determination threshold as a result of the third step.
